(19) United States
(12) Patent Application Publication
(10) Pub. No.: US 2026/0079805 A1
(43) Pub. Date: Mar. 19, 2026

(54) TECHNIQUES FOR ESTIMATION OF HIGH-RESOLUTION SURFACE TEMPERATURE MAPS IN BATTERY PACKS

(71) Applicant: Analog Devices International Unlimited Company, Limerick (IE)

(72) Inventors: Varun Kelkar, Medford, MA (US); Frank M. Yaul, Cambridge, MA (US); Philip James Brennan, Bandon (IE); Omer Tanovic, Acton, MA (US)

(21) Appl. No.: 19/330,531

(22) Filed: Sep. 16, 2025

Related U.S. Application Data
(60) Provisional application No. 63/696,125, filed on Sep. 18, 2024.

(51) Int. Cl. G06F 11/30; H01M 10/42

(52) U.S. Cl. CPC G06F 11/3058; H01M 10/4285

(57) ABSTRACT

Systems and methods for estimating battery surface temperatures comprise generating a core temperature estimate for the battery based on a battery model. A set of lumped temperature states may be generated based on the core temperature, the set of lumped temperature states comprising temperature estimates for different regions of the battery. Additional condensed information may be retrieved relating to the battery. A surface temperature map may be generated for the battery based on the set of lumped temperature states and the additional condensed information using a mapping function.

### CLAIMS OF PRIORITY

This patent application claims the benefit of priority U.S. Provisional Patent Application Ser. No. 63/696,125, titled “TECHNIQUES FOR ESTIMATION OF HIGH-RESOLUTION SURFACE TEMPERATURE MAPS IN BATTERY PACKS,” filed on Sep. 18, 2024, which is hereby incorporated by reference herein in its entirety.

### TECHNICAL FIELD

The present disclosure generally relates to battery state estimation.

### BACKGROUND

Rechargeable batteries, such as lithium-ion batteries, are commonly used for portable electronics and electric vehicles (EVs), as well as a variety of other applications, such military and aerospace applications. It is important to monitor the battery state, such as temperature, of such batteries to maximize the performance of the batteries.

For example, continuous monitoring of battery health is important for the safe adoption of EVs. High currents during fast charging and discharging can cause uneven heating of battery cells, making it important to measure their surface temperatures, such as maximum and minimum surface temperatures.

### SUMMARY

The present disclosure describes systems and methods for estimating battery surface temperatures, comprising generating a core temperature estimate for the battery based on a battery model; generating a set of lumped temperature states based on the core temperature, wherein the set of lumped temperature states comprises temperature estimates for different regions of the battery; retrieving additional condensed information relating to the battery; generating a surface temperature map for the battery based on the set of lumped temperature states and the additional condensed information using a mapping function; and determining at least one surface temperature for the battery based on the surface temperature map.

### BRIEF DESCRIPTION OF THE DRAWINGS

Various ones of the appended drawings merely illustrate example embodiments of the present disclosure and should not be considered as limiting its scope.

FIG. 1A illustrates a simplified model for a battery.

FIG. 1B illustrates a model for estimating the core temperature of a battery

FIG. 2 is a block diagram illustrating a method for estimating surface temperatures using surface temperature maps.

FIG. 3 is a block diagram illustrating a method for estimating surface temperatures in a battery pack using joint low-rank decomposition.

FIG. 4 is a process diagram illustrating low-rank decomposition of Kalman filter gain matrices across multiple battery cells.

FIG. 5 is a block diagram illustrating a method for estimating surface temperatures in a battery pack using subspace-based super-resolution techniques.

FIG. 6 is a diagram illustrating an example of a temperature grid of a battery.

FIG. 7 illustrates a block diagram of an example comprising a machine upon which any one or more of the techniques (e.g., methodologies) discussed herein may be performed.

### DETAILED DESCRIPTION

The present disclosure describes techniques for estimating surface temperature maps in battery packs that can be used to estimate different surface temperature values, such maximum, minimum, and average surface temperatures. These techniques, for example, can be used for electric vehicles and other applications to monitor battery safety and performance.

Other approaches for battery monitoring generally lack the ability to accurately track the maximum and minimum surface temperatures of individual cells within a battery pack without the extensive use of thermocouples. Other computational techniques can be constrained by memory and computational limitations and cannot provide the spatial resolution to identify localized hot or cold spots that may result in safety risks or diminished battery life.

The present disclosure describes techniques that combine model-based temperature estimates using sensor data with additional condensed information, such as physics-based models or data-driven representations derived from simulation, to generate a high-resolution map of surface temperatures across the battery pack, thereby enabling accurate identification of temperature extremes.

Enhanced safety can be achieved through accurate tracking of maximum and minimum surface temperatures, which helps prevent thermal runaway and other safety hazards. Improved performance results from high-resolution temperature mapping, which enables better thermal management and leads to optimized charging, discharging, and overall battery health.

Notably, the techniques described herein can achieve high accuracy without using a dense network of physical sensors, such as thermocouples, or excessive computational resources, making it suitable for edge-based deployment in compact battery systems, such as in electric vehicles.

Different types of models can be used for estimating battery state information, such as core temperature (or also referred to as internal temperature). For example, core temperature may be estimated using electrochemical impedance spectroscopy (EIS). In some examples, a multivariable polynomial regression model may be used.

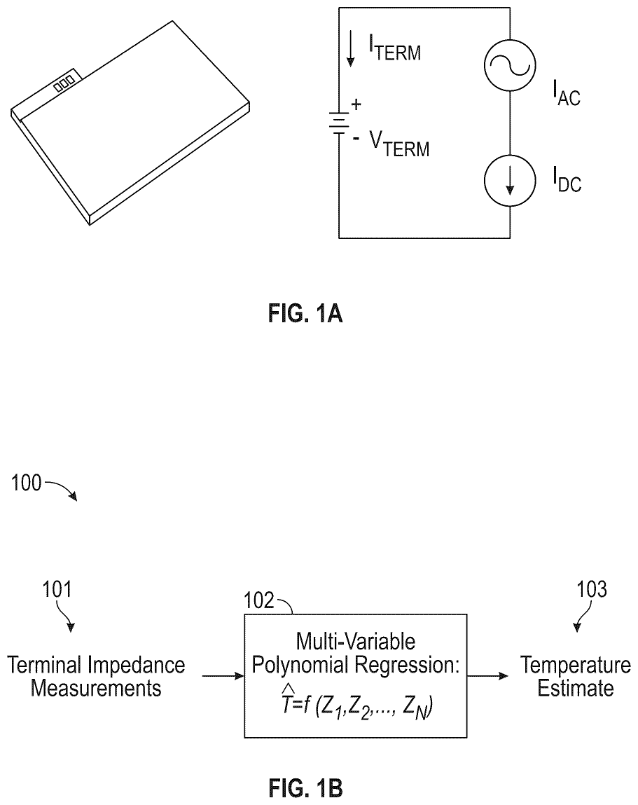

As generally illustrated in FIG. 1A, a core temperature is estimated using EIS. In some examples, a multivariable polynomial regression may be used to estimate the core temperature of a battery (such as a lithium-ion battery) using EIS techniques. For example, terminal impedance measurements may be taken at multiple frequencies of an injected sinusoidal current. In some examples, the frequencies for use are selected based on a type of battery.

FIG. 1B illustrates a block diagram of a system 100 for using multivariable polynomial regression model to estimate the core temperature of a battery from impedance measurements at multiple frequencies. As shown in FIG. 1B, terminal impedance measurements taken at a variety of frequencies (designated in FIG. 1B by a reference numeral 101) are input to a multivariable polynomial regression model 102, the output of which is a core battery temperature estimate.

Core temperature estimates may provide an average internal temperature of the battery cell, but they do not typically capture localized heating or cooling that can occur on the cell surface. Surface temperature measurements may be useful because thermal extremes, such as hot spots or cold spots, can develop at the surface, posing safety risks like thermal runaway and impacting battery performance and longevity. Monitoring surface temperatures can enable more effective thermal management and safer operation.

Next, techniques for estimating surface temperature estimates based on core temperature estimation techniques are described.

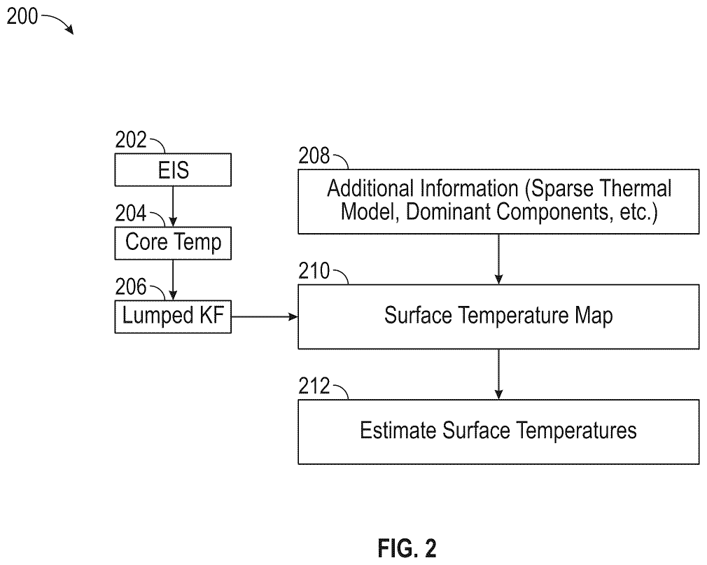

FIG. 2 is a block diagram illustrating a method 200 for estimating surface temperatures using surface temperature maps.

At block 202, EIS measurements are taken. For example, as described above, terminal impedance measurements may be taken at multiple frequencies of an injected sinusoidal current.

At block 204, a core temperature estimate is generated based on the EIS measurements using a battery model, as described above. For example, a multivariable polynomial regression model may be used to estimate the core temperature of the battery from impedance measurements at multiple frequencies.

At block 206, the core temperature estimate may be input to a lumped Kalman filter (KF) module to output a set of lumped temperature states. In some examples, additional sensor data, such as temperature readings from a small set of thermocouples attached to specified locations of the battery, may also be input to the lumped KF module to generate the set of lumped temperature states. The thermocouples may include Negative Temperature Coefficient (NTC) thermistors.

Lumped temperature states may include temperature estimates calculated for different regions or segments within a battery cell, rather than for individual points or the entire cell as a whole. The lumped KF module may aggregate the input data and physical properties of the battery to estimate the average temperature in each region (or state). The lumped temperate states may include values such as T_{core}, T_{lumped1}, T_{lumped2}, . . . , T_{lumpedk}, and T_{NTC}., where T_{core} represents the core temperature estimate, T_{lumped1}, T_{lumped2}, . . . , T_{lumpedk} represent the estimated temperatures of different regions, an T_{NTC} represents temperature reading obtained from one or more NTC thermistors placed at specific locations on the battery cell surface. While lumped temperature states can provide more spatial detail than a single core temperature estimate, these lumped temperature states can still lack the resolution to pinpoint localized hot or cold spots on the cell surface.

At block 208, additional condensed information relating to the battery is obtained. Additional condensed information may include supplementary data or model representations that enhance the accuracy of surface temperature estimation, as described in further detail below.

The information is referred to as “condensed” because it may capture, for example, dominant features or patterns of heat distribution within the battery using a reduced set of data or model parameters, instead of relying on full, high-dimensional thermal models or extensive sensor networks. The information may be condensed to conserve memory and computational resources. Condensed information may summarize the most relevant aspects in a compact form, minimizing memory and computational usage while still enabling accurate surface temperature estimation. The additional condensed information may include sparse thermal models, dominant components identified from simulation data, or other physics-based or data-driven features that capture heat distribution characteristics within the battery.

At block 210, a surface temperature map is generated based on the lumped temperature states and the additional condensed information. A mapping function may be used to combine the lumped temperature states and the additional condensed information. For example, a mapping function Φ may generate a high-resolution surface temperature map as a function of the lumped temperature states and the position S on the cell surface.

A surface temperature map may include a representation of temperature values distributed across the surface of a battery cell. The map may be provided in high resolution. The surface temperature map may provide detailed spatial information about how temperature varies at different locations on the cell surface.

At block 212, surface temperature estimates are generated based on the surface temperature map. For example, maximum, minimum, and average surface temperatures across the battery surface may be generated. For example, the maximum surface temperature Tₘₐₓ and minimum surface temperature Tₘᵢₙ may be computed as follows:

$${T}_{max} = {max}_{S} Φ ( {T}_{core} , {T}_{lumped [ 1 ... k ]} , {T}_{NTC} , S )$$

$${T}_{min} = {min}_{S} Φ ( {T}_{core} , {T}_{lumped [ 1 ... k ]} , {T}_{NTC} , S )$$

By integrating condensed information (rather than full information) with the lumped temperature states, the system can generate high-resolution surface temperature maps, which are then used for surface temperature estimates, without using extensive sensor networks or computational resources. As such, method 200 may be performed on an edge-based deployment, such as in an electric vehicle, where memory and computational resources may be limited.

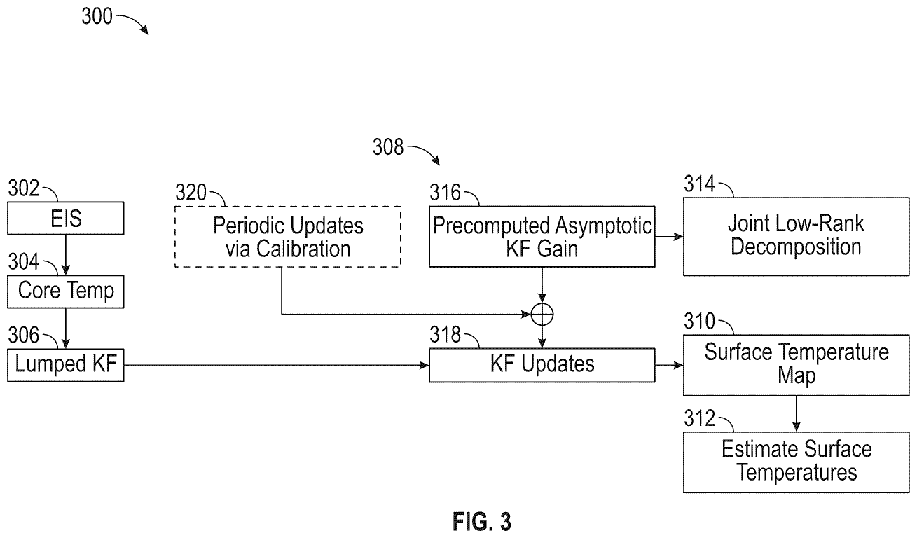

FIG. 3 is a block diagram illustrating a method 300 for estimating surface temperatures in a battery pack using joint low-rank decomposition.

At block 302, EIS measurements are taken. For example, terminal impedance measurements may be obtained at multiple frequencies of an injected sinusoidal current, as described above.

At block 304, a core temperature estimate is generated based on the EIS measurements using a battery model, as described above.

At block 306, the core temperature estimate may be input to a lumped KF module to output a set of lumped temperature states, as described above.

At block 308, additional condensed information relating to the battery is obtained, which in this case includes sparse thermal model parameters, such as asymptotic KF gain values, obtained using joint low-rank decomposition, as described in further detail below.

At block 314, joint low-rank decomposition is performed to compress the Kalman filter gain matrices across multiple battery cells, as described below in further detail. The precomputed asymptotic KF gain, shown at block 316, is periodically updated via calibration (block 320).

At block 318, the lumped temperature states are refined by applying KF update equations. The system incorporates the compressed KF gain matrices, which are obtained through joint low-rank decomposition. By integrating these gain matrices with the lumped temperature states, the KF updates module efficiently computes improved temperature estimates for different regions of the battery.

At block 310, a surface temperature map is generated based on the KF update equations. A mapping function may be used to generate a high-resolution surface temperature map as a function of the lumped temperature states and the position on the cell surface, as described above. A surface temperature map includes a representation of temperature values distributed across the surface of a battery cell, providing high-resolution, detailed spatial information about how temperature varies at different locations on the cell surface.

At block 312, surface temperature estimates, such as maximum, minimum, and average surface temperatures, are generated based on the surface temperature map, as described above.

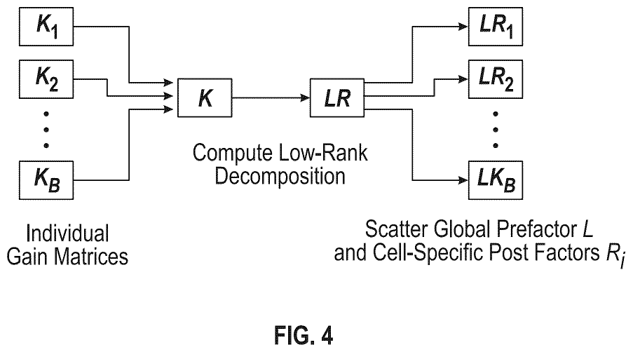

FIG. 4 is a process diagram illustrating low-rank decomposition of Kalman filter gain matrices across multiple battery cells. As described below, the use of low-rank decomposition can enable efficient and scalable battery state estimation. Joint low-rank decomposition enables efficient compression and distribution of Kalman filter gain matrices, leveraging the asymptotic stability and highly sparse, convolutional nature of the thermal model.

As shown in FIG. 4, individual high-dimensional Kalman filter gain matrices K₁, K₂, . . . , K_{B} are first gathered from each battery cell, where each matrix has dimensions N×n (e.g., 165×6), with N being the number of grid points in the high-resolution state and n the number of lumped KF states. These individual matrices are combined to form a single, aggregated gain matrix K of size N×(nB), where B is the number of battery cells.

This aggregation and compression process is described by the following set of equations, with the first equation being:

$$𝒦 = [ {K}_{1} \vert {K}_{2} \vert ... \vert {K}_{B} ] ∈ {ℝ}^{N \times ( {B}_{n} )}$$

represents the concatenation of individual Kalman filter gain matrices K₁, K₂, . . . , K_{B} from each of the B battery cells. Each matrix Kᵢ has dimensions N×n. The resulting aggregated matrix K has N rows and nB columns.

The second equation,

$$K \approx LR = [ {LR}_{1} {LR}_{2} … {LR}_{B} ] ,$$

shows that the aggregated gain matrix K can be efficiently approximated by a product of two matrices: a global prefactor matrix L of size N×M, and a set of cell-specific post-factor matrices Ri of size M×n, where M is the rank of the reduced-rank decomposition. This low-rank representation significantly reduces the memory and computational requirements, as only the global matrix L and the smaller cell-specific matrices Ri may be stored, for example, in the edge-based deployment and used for further calculations, rather than the full set of high-dimensional gain matrices.

A low-rank decomposition is performed on K using singular value decomposition (SVD), resulting in a set of low-rank matrices denoted as L and R. The decomposition solves for L and R such that:

$$L , R = arg {min}_{L , R} ‖ K - LR ‖$$

where L is a global prefactor matrix of size N×M and each Ri is a cell-specific post-factor matrix of size M×n, with M being the rank of the reduced-rank matrices (typically much smaller than nB).

Following the decomposition, the process scatters the results into the global prefactor matrix L, which is stored once for the entire battery pack, and cell-specific post-factor matrices Ri, which are distributed to each battery cell. This approach reduces the memory footprint from nNB to NM+MnB, achieving a reduction by at least two orders of magnitude compared to storing full gain matrices for every cell.

Joint low-rank decomposition enables efficient compression and distribution of Kalman filter gain matrices, leveraging the asymptotic stability and highly sparse, convolutional nature of the thermal model. In some examples, joint low-rank decomposition of Kalman filter gain matrices, as described above, may be performed at a central location, such as a server or cloud-based system or at a manufacturing facility or on a vehicle's central computing system, where computational resources are more extensive and available. In this process, the high-dimensional gain matrices from multiple battery cells are aggregated and decomposed into a global prefactor matrix and cell-specific post-factor matrices. Once the decomposition is complete, only the compact gain values, including the global and cell-specific matrices, are stored and deployed to the edge-based battery management systems. This approach minimizes memory and computational requirements at the edge, enabling efficient real-time temperature estimation in different environments, such as in electric vehicles.

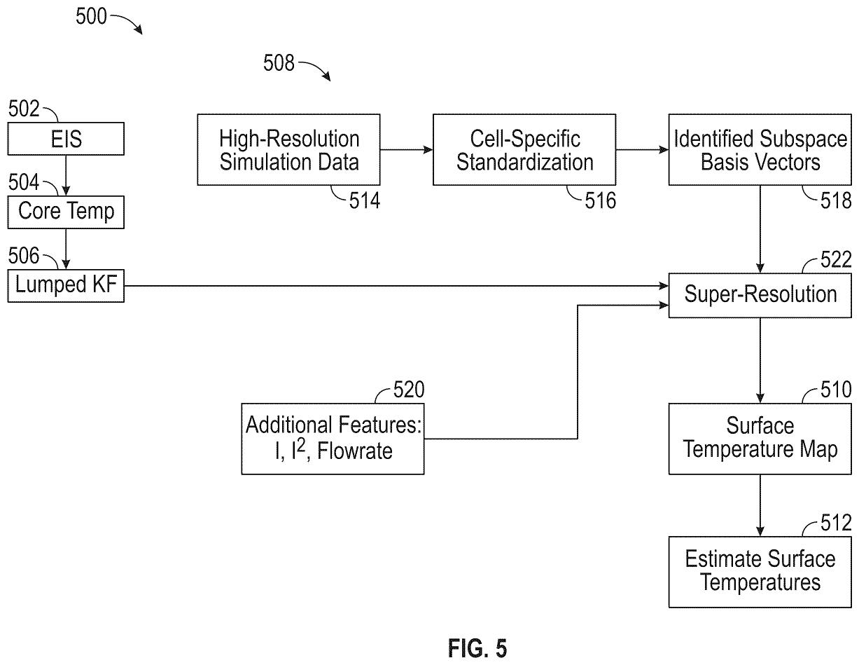

FIG. 5 is a block diagram illustrating a method 500 for estimating surface temperatures in a battery pack using subspace-based super-resolution techniques.

At block 502, EIS measurements are taken. For example, terminal impedance measurements may be obtained at multiple frequencies of an injected sinusoidal current, as described above.

At block 504, a core temperature estimate is generated based on the EIS measurements using a battery model, as described above.

At block 506, the core temperature estimate may be input to a lumped KF module to output a set of lumped temperature states, as described above.

At block 508, additional condensed information relating to the battery is obtained, which in this case include dominant components of the heating profile of the battery. For example, simulation data can be used to identify subspaces that have a dominant effect on the heating profile of the battery. The subspaces can be used for super-resolution mapping, as described below.

At block 514, high-resolution simulation data is obtained, representing detailed temperature profiles under various operating conditions.

At block 516, cell-specific standardization is performed to account for differences between individual battery cells, so that the simulation data and measured states are properly aligned.

At block 518, subspace identification is performed, for example using principal component analysis (PCA), to extract a set of basis vectors that capture the dominant modes of temperature variation observed in the simulation data.

At block 520, additional features, such as current (I), squared current (I²), and coolant flow rate, are incorporated to further refine the temperature estimation process.

At block 522, the identified subspace basis vectors and additional features are combined with the lumped temperature states using a super-resolution algorithm. This process leverages the learned relationship between the low-dimensional lumped states and the high-resolution temperature profiles, enabling the generation of a higher-resolution temperature map at block 510.

A mapping function may be used to a high-resolution surface temperature map as a function of the lumped temperature states and the position on the cell surface, as described above. A surface temperature map includes a representation of temperature values distributed across the surface of a battery cell, providing high-resolution, detailed spatial information about how temperature varies at different locations on the cell surface.

At block 512, surface temperature estimates, such as maximum, minimum, and average surface temperatures, are generated based on the surface temperature map, as described above.

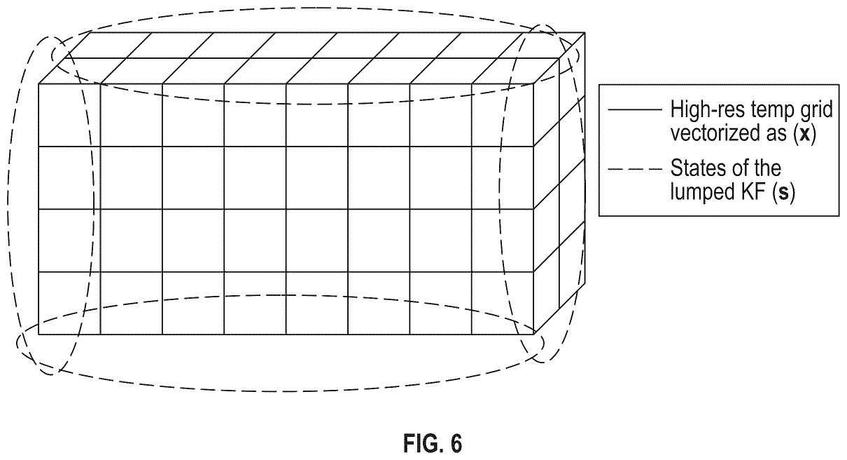

Techniques for determining dominant components of the heating profile of the battery are described next. FIG. 6 is a diagram illustrating an example of a temperature grid of a battery.

Temperature profiles under normal conditions can be fairly regular and smooth, and may be assumed to lie in a low-dimensional affine subspace:

$$x = Uz , z ∈ {ℝ}^{K} ,$$

where x represents the high-resolution temperature grid vector, containing temperature values at each location on the battery cell surface; U is a matrix of basis vectors, which capture the dominant patterns of temperature variation; and z is a latent variable vector that provides the coefficients for combining the basis vectors in U to reconstruct the full temperature profile x across the cell surface. U can be determined by performing PCA over the simulated data.

The lumped KF states vector s can be related to vector x via operator H, such that s=Hx.

The high-resolution temperature grid x itself is assumed to lie in a low-dimensional manifold. For example, one possible example of such a manifold is an affine subspace parameterized by basis vectors U and latent variables z, so that x=Uz.

Given the lumped KF state vector s and the subspace basis U, the interpolated temperature profile can be computed using the relationship:

$$x = {U ( HU )}^{+} s ,$$

where (HU)⁺ denotes the Moore-Penrose pseudoinverse.
To account for differences between individual battery cells, cell-specific normalization and Tikhonov regularization may be incorporated, resulting in the following computation:

$$x = {\sum }_{i} {U ( H {\sum }_{i} U )}^{+} s + [ I - {\sum }_{i} {U ( H {\sum }_{i} U )}^{+} H ] {m}_{i}$$

where mᵢ and Σᵢ are the cell-specific pixelwise mean and standard deviation, respectively.

In some examples, computation can be further reduced to:

$$= U ( V {σ}_{i} ) \begin{matrix}+ \\ λ\end{matrix} s + {μ}_{i}$$

where Vϵ [symbol] , σᵢϵ [symbol] , μᵢϵ [symbol] , n_{search}: number of pixels to search max and min over.

This approach allows the system to store and process only tens of additional numbers per cell, rather than hundreds as required by traditional lumped Kalman filter methods. As a result, the memory cost is similar to adding one extra state, making the method highly efficient and scalable for edge-based battery management applications.

In some examples, subspace identification may be performed at a central location, such as a server or cloud-based system or a manufacturing facility or on a vehicle's central computing system, using high-resolution simulation data collected under various operating conditions. In this process, PCA or similar techniques are applied at the central location to extract a set of basis vectors that capture the dominant modes of temperature variation across battery cells. Once the subspace basis vectors and cell-specific normalization parameters are determined, only these compact representations are stored and deployed to the edge-based battery management systems. This enables efficient, real-time reconstruction of high-resolution temperature profiles on the edge device, while minimizing memory and computational requirements.

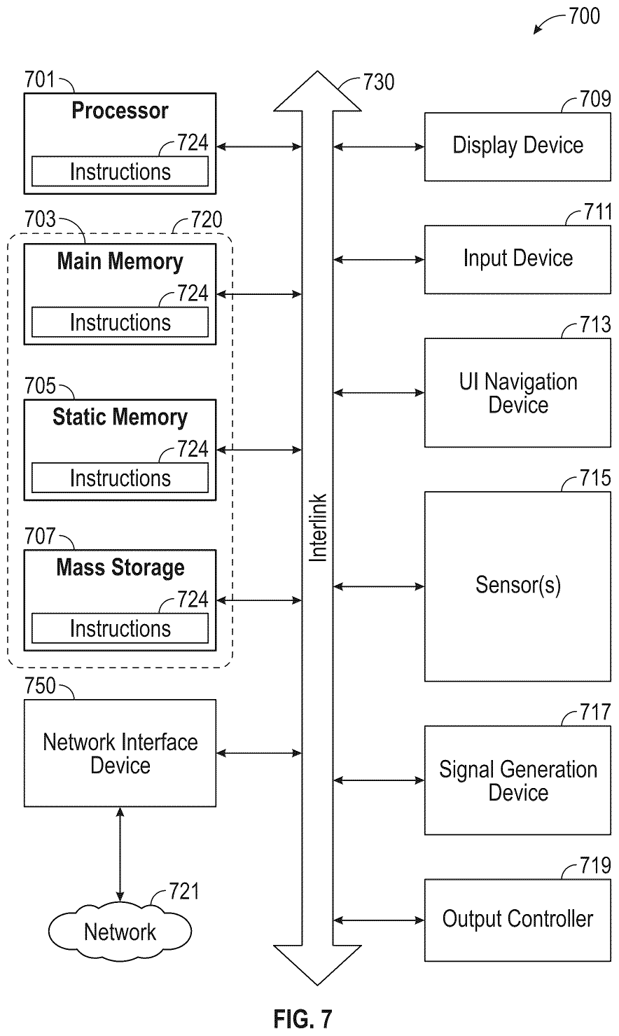

The techniques shown and described in this document can be performed using a portion or an entirety of battery monitoring system as described above or otherwise using a machine 700 as discussed below in relation to FIG. 7. FIG. 7 illustrates a block diagram of an example comprising a machine 700 upon which any one or more of the techniques (e.g., methodologies) discussed herein may be performed. In various examples, the machine 700 may operate as a standalone device or may be connected (e.g., networked) to other machines.

In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet device, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer-readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 700 (e.g., computer system) may include a hardware-based processor 701 (e.g., a central processing unit (CPU), a graphics processing unit (GPU), a hardware processor core, or any combination thereof), a main memory 703 and a static memory 705, some or all of which may communicate with each other via an interlink 730 (e.g., a bus). The machine 700 may further include a display device 709, an input device 711 (e.g., an alphanumeric keyboard), and a user interface (UI) navigation device 713 (e.g., a mouse). In an example, the display device 709, the input device 711, and the UI navigation device 713 may comprise at least portions of a touch screen display. The machine 700 may additionally include a storage device 720 (e.g., a drive unit), a signal generation device 717 (e.g., a speaker), a network interface device 750, and one or more sensors 715, such as a global positioning system (GPS) sensor, compass, accelerometer, or other sensor. The machine 700 may include an output controller 719, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices (e.g., a printer, a card reader, etc.).

The storage device 720 may include a machine readable medium on which is stored one or more sets of data structures or instructions 724 (e.g., software or firmware) embodying or utilized by any one or more of the techniques or functions described herein. The instructions 724 may also reside, completely or at least partially, within a main memory 703, within a static memory 705, within a mass storage device 707, or within the hardware-based processor 701 during execution thereof by the machine 700. In an example, one or any combination of the hardware-based processor 701, the main memory 703, the static memory 705, or the storage device 720 may constitute machine readable media.

While the machine readable medium is considered as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 724 may further be transmitted or received over a communications network 721 using a transmission medium via the network interface device 750 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known as Wi-Fi®, the IEEE 802.26 family of standards known as WiMax®), the IEEE 802.27.4 family of standards, peer-to-peer (P2P) networks, among others. In an example, the network interface device 750 may include one or more physical jacks (e.g., Ethernet, coaxial, or phone jacks) or one or more antennas to connect to the communications network 721. In an example, the network interface device 750 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the invention can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description as examples or implementations, with each claim standing on its own as a separate implementation, and it is contemplated that such implementations can be combined with each other in various combinations or permutations. The scope of the invention should be determined with reference to the appended claims, along with the full scope of equivalents to which such claims are entitled.

1. A method for estimating battery surface temperatures, comprising:
generating a core temperature estimate for the battery based on a battery model;
generating a set of lumped temperature states based on the core temperature, wherein the set of lumped temperature states comprises temperature estimates for different regions of the battery;
retrieving additional condensed information relating to the battery;
generating a surface temperature map for the battery based on the set of lumped temperature states and the additional condensed information using a mapping function; and
determining at least one surface temperature for the battery based on the surface temperature map.

2. The method of claim 1, wherein the set of lumped temperature states are generated using a lumped Kalman filter module.

3. The method of claim 1, wherein the additional condensed information comprises sparse thermal model components.

4. The method of claim 3, wherein the sparse thermal model components comprise a global prefactor matrix and a set of cell-specific post-factor matrices.

5. The method of claim 4, wherein the global prefactor matrix and the set of cell-specific post-factor matrices are generated by performing joint low-rank decomposition on Kalman gain matrices aggregated from multiple cells.

6. The method of claim 1, wherein the additional condensed information comprises dominant components of heat distribution within the battery based on simulation data.

7. The method of claim 6, wherein the dominant components are identified by performing principal component analysis to generate basis vectors representing dominant modes of temperature variation.

8. The method of claim 1, wherein the method is performed on an edge-based device,

9. The method of claim 8, wherein the additional condensed information is generated at a central device and stored on the edge-based device and retrieved from a memory on the edge-based device.

10. The method of claim 1, further comprising:
receiving electrochemical impedance spectroscopy (EIS) measurements from a battery, wherein the core temperature estimate is based on the EIS measurements.

11. A system comprising:
at least one hardware processor; and
at least one memory storing instructions that, when executed by the at least one hardware processor, cause the at least one hardware processor to perform operations comprising:
generating a core temperature estimate for the battery based on a battery model;
generating a set of lumped temperature states based on the core temperature, wherein the set of lumped temperature states comprises temperature estimates for different regions of the battery;
retrieving additional condensed information relating to the battery;
generating a surface temperature map for the battery based on the set of lumped temperature states and the additional condensed information using a mapping function; and
determining at least one surface temperature for the battery based on the surface temperature map.

12. The system of claim 11, wherein the set of lumped temperature states are generated using a lumped Kalman filter module.

13. The system of claim 11, wherein the additional condensed information comprises sparse thermal model components.

14. The system of claim 11, wherein the sparse thermal model components comprise a global prefactor matrix and a set of cell-specific post-factor matrices.

15. The system of claim 11, wherein the global prefactor matrix and the set of cell-specific post-factor matrices are generated by performing joint low-rank decomposition on Kalman gain matrices aggregated from multiple cells.

16. The system of claim 11, wherein the additional condensed information comprises dominant components of heat distribution within the battery based on simulation data.

17. The system of claim 11, wherein the dominant components are identified by performing principal component analysis to generate basis vectors representing dominant modes of temperature variation.

18. The system of claim 11, wherein the additional condensed information is generated at a central device and stored on the edge-based device and retrieved from a memory on the edge-based device.

19. The system of claim 11, further comprising:
receiving electrochemical impedance spectroscopy (EIS) measurements from a battery, wherein the core temperature estimate is based on the EIS measurements.

20. A machine-storage medium embodying instructions that, when executed by a machine, cause the machine to perform operations comprising:
generating a core temperature estimate for the battery based on a battery model;
generating a set of lumped temperature states based on the core temperature, wherein the set of lumped temperature states comprises temperature estimates for different regions of the battery;
retrieving additional condensed information relating to the battery;
generating a surface temperature map for the battery based on the set of lumped temperature states and the additional condensed information using a mapping function; and
determining at least one surface temperature for the battery based on the surface temperature map.
